(19) United States
(12) Patent Application Publication
(10) Pub. No.: US 2012/0033438 A1
(43) Pub. Date: Feb. 9, 2012

(54) LUMINAIRE AND LAMPHOLDER THEREFOR

(75) Inventor: Bruce McCallum, North Shore City (NZ)

(73) Assignee: KONINKLIJKE PHILIPS ELECTRONICS N.V., EINDHOVEN (NL)

(21) Appl. No.: 13/129,904

(22) PCT Filed: Nov. 20, 2009
(86) PCT No.: PCT/IB09/55245

§ 371 Date: Sep. 19, 2011

(30) Foreign Application Priority Data
Nov. 27, 2008 (NZ) 573231

(51) Int. Cl. F21S 8/00

(52) U.S. Cl. 362/430

(57) ABSTRACT

The invention concerns the selection of relevant advertisements for presentation on a portable computing device. The device has stored in memory multiple advertisements where each advertisement is associated with one or more advertisement descriptors. Based on the dynamic and heterogeneous content presented (98) on the device (10), content descriptors are identified (100). Next, content descriptors are compared (102) to advertisement descriptors stored in memory to select and advertisement and present (104) it on the device (10). This invention identifies that many portable devices are continually used without being online (i.e. being offline). It is an advantage of the invention that relevant advertisements can be selected and displayed on a portable device while the device is offline and no reliance is placed on an external network or external device as the device can decide what advertisements to display and when. Aspects of the invention include a method performed by the device, the device and software for installation on the device.

### FIELD OF THE INVENTION

The present invention relates to an adjustable luminaire and/or an adjustable mechanism for use in a luminaire for holding and adjusting an illumination source, such as a lamp.

### BACKGROUND OF THE INVENTION

Luminaires are lighting apparatus used in stage lighting and the like. They comprise an outer generally cylindrical housing that can be suspended from a lighting rig or similar. A luminaire comprises a illumination source (such as a lamp) that projects light towards a lens in the housing. The light exits the lens and illuminates the desired area. The lamp is usually mounted in a holder or similar towards or at the rear of the housing.

When mounting the lamp in the holder, generally it is difficult or impossible to make the elongated lamp perfectly aligned with the longitudinal axis of the housing. As a result, the light emanating from the lamp will be slightly misaligned or off-centre, resulting in reduced performance.

Mechanisms have been provided to assist in adjusting the alignment of the lamp, but these are typically awkward to use.

### SUMMARY OF THE INVENTION

It is an object of the present invention to provide a more convenient adjustment mechanism for an illumination source in a luminaire or similar lighting apparatus, or at least to provide the public with a useful choice.

In one aspect the present invention may be said to consist in an adjustable holder for mounting an illumination source in a luminaire or other lighting apparatus, the holder comprising a mount adapted to hold a lamp or other illumination source and one or more independently adjustable camming surfaces each adapted to directly or indirectly exert a force on the mount to set the mount's tilt.

In another aspect the present invention may be said to consist in an adjustable holder for an illumination source, the holder comprising a first mount adapted to hold a lamp or other illumination source and a second mount adapted to couple the holder to a luminaire or other lighting apparatus, wherein the first mount can be tilted relative to the second mount via one or more camming surfaces that each directly or indirectly exert a force against a respective position on the first mount, the camming surfaces being independently moveable to adjust the force exerted. In another aspect the present invention may be said to consist in an adjustable holder for an illumination source, the holder comprising:

a first mount adapted to hold a lamp or other illumination source,

a second mount adapted to couple the first mount to a luminaire or other light apparatus, and

one or more camming surfaces, each moveably coupled to the second mount and adapted to bear directly or indirectly against the first mount or part thereof,

wherein each camming surface can be manipulated into a range of positions, each position setting a displacement between the second mount and a portion of the first mount.

Preferably the tilt of the first mount relative to the second mount can be configured by manipulating each camming surface into one of a range of positions.

Preferably each camming surface comprises a ramp that slides relative to the second mount.

Preferably each camming surface bears against a protrusion extending from or coupled to the first mount.

Preferably the holder comprises one or more biases to bias the first mount or part thereof against each camming surface.

Preferably each bias comprises a pin extending between the second mount and the first mount, and a biasing spring bearing between the pin and the first mount to bias the first mount or part thereof directly or indirectly against one or more camming surfaces.

Preferably there are three camming surfaces each comprising a ramp that is slidably engaged proximate the surface of the second mount, each camming surface being circumferentially curved and slidable at least partially around the second mount, and each bias comprises a pin extending through an elongated curved slot in each camming surface to couple the first and second mount, the pin comprising a bearing means from which the bias spring extends and bears against the first mount to bias the first mount or part thereof directly or indirectly against the camming surface.

Preferably the protrusion is integrally formed with the first mount.

Preferably the protrusion is disposed on the pin between the first mount and the camming surface. Preferably a protrusion extends from each camming surface for manipulation of the camming surface.

In another aspect the present invention may be said to consist in a luminaire comprising an adjustable holder according to any one of the above statements.

Preferably the first mount is coupled to the second mount via a threaded insert, wherein rotation of the second mount retracts and/or extends the threaded insert to adjust the axial position of the first mount to adjust peak/flat of an installed lamp or other illumination device.

Preferably the first mount or part thereof can be extracted from the second mount to remove the lamp.

In another aspect the present invention may be said to consist in a luminaire with an adjustable holder for mounting an illumination source in a luminaire or other lighting apparatus, the holder comprising a mount adapted to hold a lamp or other illumination source and one or more independently adjustable camming surfaces each adapted to directly or indirectly exert a force on the mount to set the mount's tilt.

In another aspect the present invention may be said to consist in an adjustable holder for mounting an illumination source in a luminaire or other lighting apparatus, the holder comprising a mount adapted to hold a lamp or other illumination source wherein the first mount is coupled to a second mount via a threaded insert, wherein when the second mount is installed in a luminaire, rotation of the second mount retracts and/or extends the threaded insert to adjust the axial position of the first mount to adjust peak/flat of an installed lamp or other illumination device.

In another aspect the present invention may be said to consist in a luminaire with an adjustable holder for mounting an illumination source in a luminaire or other lighting apparatus, the holder comprising a mount adapted to hold a lamp or other illumination source wherein the first mount is coupled to a second mount via a threaded insert, wherein the second mount is coupled to the luminaire, and wherein rotation of the second mount retracts and/or extends the threaded insert to adjust the axial position of the first mount to adjust peak/flat of an installed lamp or other illumination device.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The term “comprising” as used in this specification means “consisting at least in part of”. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred embodiments of the invention will be described with reference to FIGS. 1-6, which show various views of an adjustable holder for an illumination source for use in a luminaire or other lighting apparatus.

FIG. 1a shows perspective view of the adjustable holder,

FIG. 1b is an exploded view of the adjustable holder,

FIGS. 2a-2d show various perspective views of the adjustable holder,

FIG. 3 shows a plan view of the adjustable holder,

FIG. 4a shows top, front and side elevation views of the adjustable holder,

FIG. 4b shows a back view of the adjustable holder,

FIG. 4c shows a cross section elevational view of the adjustable holder,

FIG. 5a shows a back view of the adjustable holder with the adjustment machine screws visible,

FIGS. 5b and 5c show the adjustable holder arranged in different positions to adjust peak and flat,

FIG. 6a shows a plan and side elevation cross sectional view of the adjustable holder in a luminaire, and

FIG. 6b is a perspective view of the adjustable holder installed in a portion of a luminaire.

### DETAILED DESCRIPTION OF PREFERRED EMBODIMENTS

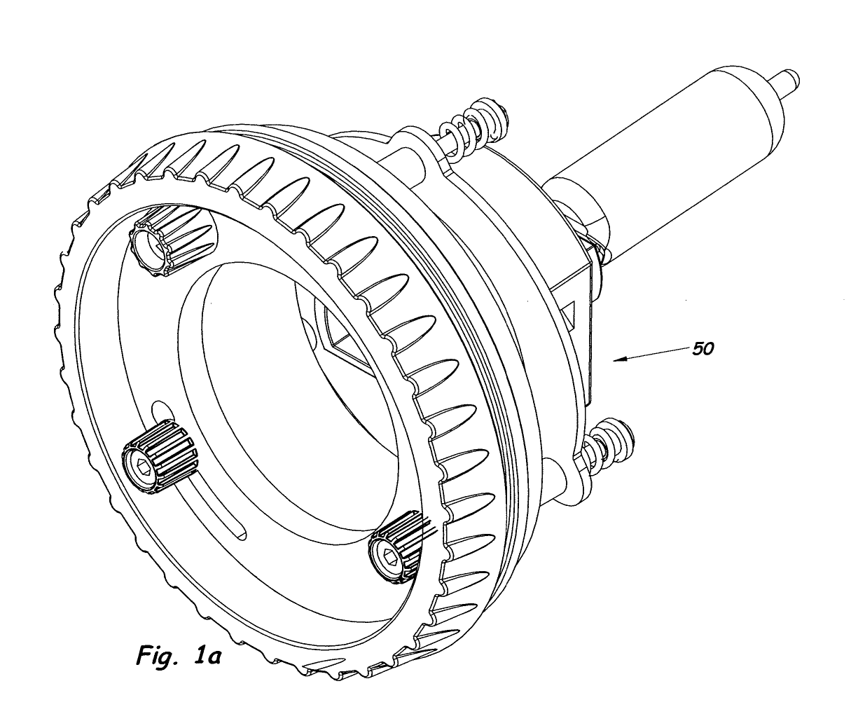

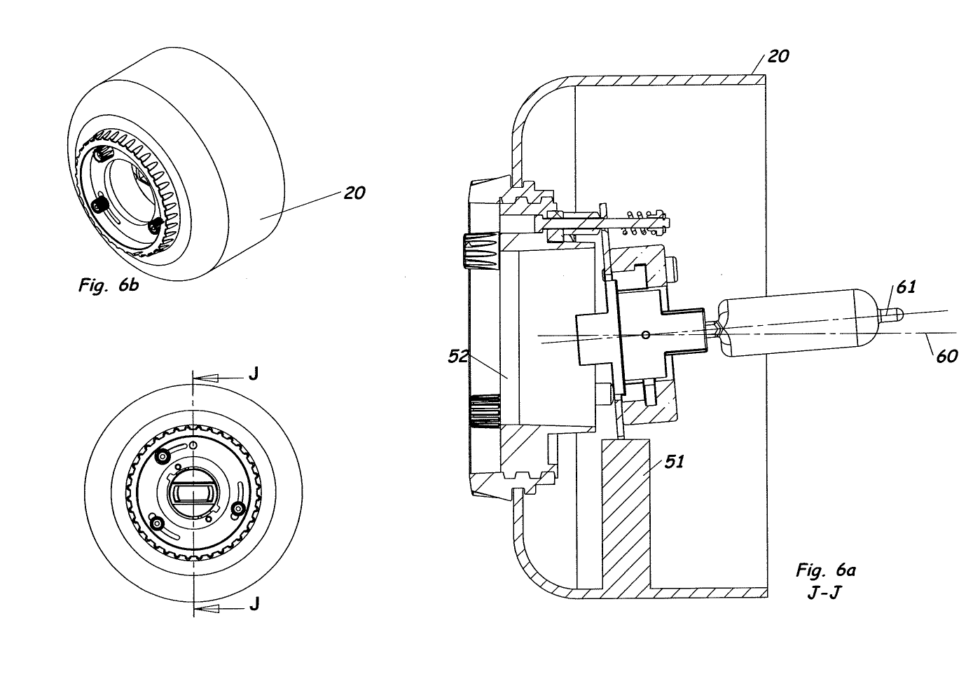

A preferred embodiment of an adjustable holder 50 for an illumination source will be described with reference to FIGS. 1a-6b. The adjustable holder 50 is adapted for use in a luminaire 20 or other lighting apparatus, such as that shown in FIG. 6a. The adjustable holder is adapted to hold a lamp 13, which can be fitted at an appropriate time. The holder 50 can be provided as a separate assembly for inserting into a luminaire, or it can be provided ready installed with a luminaire. The lamp can be provided with the assembly or installed at a later date. The present invention will refer to a lamp 13 as the illumination source and a luminaire as the lighting apparatus. The use of these terms should not be considered limiting.

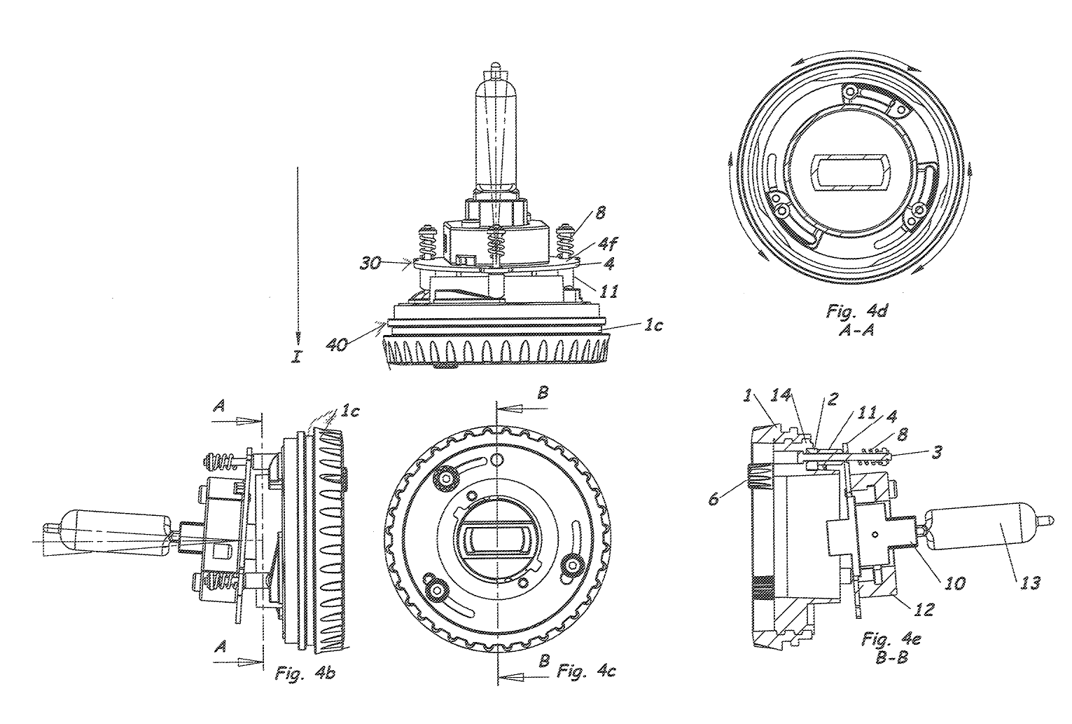

Referring to FIG. 1a, in general terms the adjustable holder 50 is an assembly comprising a first (lamp) mount (generally shown as 30 in e.g. FIG. 4a) for holding a lamp 13, and a second (luminaire) mount (generally shown as 40 in e.g. FIG. 4a) for mounting the assembly on to a luminaire 20. The first mount and the second mount are coupled together. Provided as part of that coupling (or separate to the coupling) are one or more camming surfaces 2 that are independently movable on the second mount. The camming surfaces 2 control the displacement between the first mount 30 and the second mount 40, each controlling displacement to a different degree as desirable. Each of the camming surfaces 2 control the displacement between the first and second mount at a different position. By independently moving each of the camming surfaces 2, the relative displacements at each of the positions on the first mount can be individually set to configure the first mount 30 such that it tilts with respect to the second mount 40. By tilting the first mount 30 to the desired degree, the lamp 13 can be aligned with the longitudinal axis 50 (see FIG. 6a) of the luminaire 20.

The holder 50 will now be described in further detail with respect to all FIG. 1a to 6b. The holder comprises a lamp socket 10 that is shaped to receive a luminaire lamp 13 such as a Philips fast fit lamp 50V/650W. The lamp socket 10 is retained in a lamp base (socket holder) 12. The lamp base comprises a central aperture 12a and has formed therein two bayonet receiving channels 12b, 12c. The socket 10 comprises a cylindrical body 10a that is adapted to slide through and fit within the socket holder aperture 12a. Two bayonet protrusions 10b, 10c (of which 10b is visible in FIG. 1) are adapted to fit within the bayonet channels 12b, 12c of the lamp base 12. The lamp socket 10 can be inserted in place and rotated to lock the bayonets 10b, 10c in position in the respective channels 12b, 12c. The lamp 13 then protrudes through from the lamp socket 10 through the lamp base 12.

The lamp base 12 is coupled to a lamp base mounting plate 4 using two fixing screws 15a, 15b. The fixing screws extend through the lamp base 12 and locate in corresponding apertures 4a, 4b in the mounting plate 4. The lamp socket 10, lamp base 12 and mounting plate 4 form the lamp mount 30 (see, e.g. FIG. 4a).

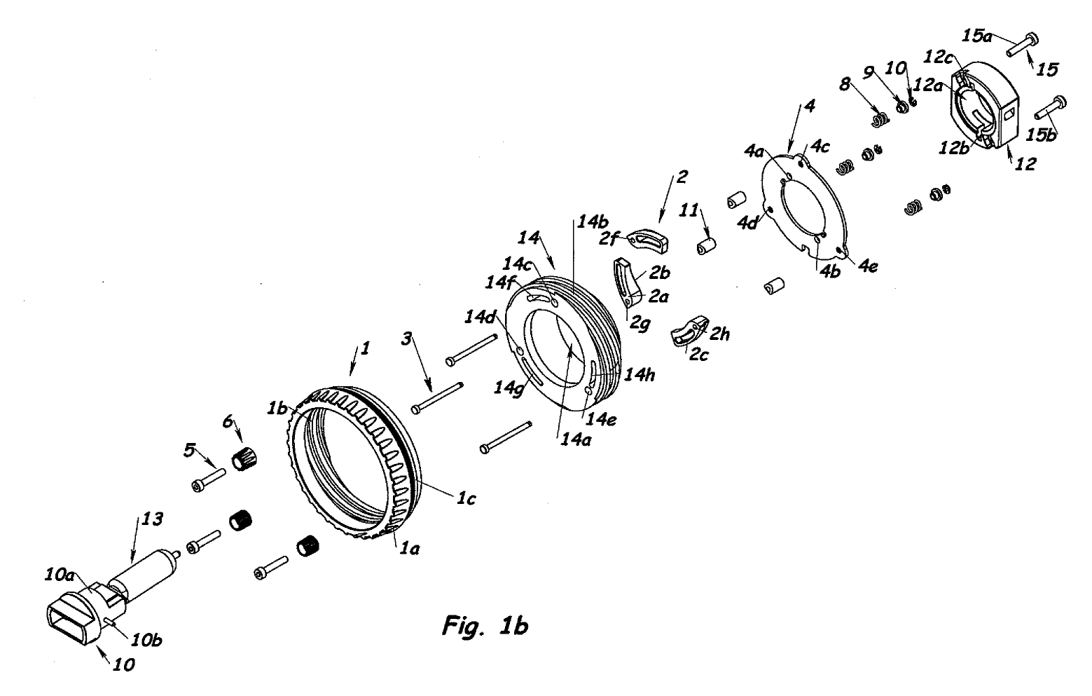

The adjustable holder 50 further comprises the luminaire mount 40 (see, e.g. FIG. 4a). This is coupled to the lamp mount and is adapted to couple to a luminaire 20 or other lighting apparatus. The luminaire mount 40 comprises a threaded dial 1. This comprises an annular ring with a moulded outer surface 1a for manual rotation. The inner surface of the ring comprises a multi-start thread 1b. The threaded dial 1 also comprises on its outer surface a annular channel 1c (see, e.g. FIG. 4a) sitting beneath the moulded outer surface for retaining the dial within the casing of the luminaire 20. The luminaire mount 40 also functions as a peak/flat adjustment mechanism for the lamp 13. A peak/flat multi-start threaded insert 14 is also provided. It comprises an annular ring with a central aperture 14a and a multi-start outer diameter thread 14b. The multi-start threaded insert is threaded within the threaded dial 1. The threaded insert 14 comprises a central boss and an outer circumferential lip that together define a slidable curved channel 25 (see, e.g., FIG. 2c).

The luminaire mount 40 (which also functions as a peak flat adjustment) is coupled to the lamp mount 30, as mentioned previously. The coupling comprises three plate bolts 3 extend through corresponding apertures 14c, 14d, 14e that extend through the threaded insert 14. The plate bolts 3 also extend through slots in the camming surfaces 2 and adjustment bosses 11 (both to be described later) and through corresponding mounting plate apertures 4c, 4d and 4e. A spring washer 9 and circlip 10 attached to the distal end of each plate bolt 3. A lamp centring biasing spring 8 is slid over each of the plate bolts 3 prior to assembling the spring washer 9 and circlip 10. The coupling holds the luminaire mount 40 coupled to the lamp mount 30. The bias springs 8 each bear against the spring washer/circlip 9, 10 and exert a bias force against the mounting plate on side 4f. This biases the mounting plate 4 towards (direction A) the luminaire mount 40 such that the mounting plate 4 bears indirectly against the camming surfaces 2 via the bosses 11. The level of biasing can be adjusted by rotating the plate bolts 3.

The coupling also functions as a lamp alignment adjuster, the details of which will now be described. Each camming surface 3 comprises a machined block or similar 2 that has a substantially flat surface 2a and a ramp surface 2b. Each block 2 is curved in a circumferential manner to match the general curved nature of the circumference of the luminaire mount and more particularly the curved channel 25.

Each of the camming surfaces 2 are curved commensurately with the channel and are engaged therein. Each camming surface 2 can slide circumferentially within the channel. Each camming surface 2 further comprises an arcuate slot 2c extending through the machined block 2. A corresponding arcuate aperture 14f -14h is provided within the body of the threaded insert 14 corresponding to the position of the respective camming surface 2.

As mentioned previously, each plate bolt 3 extends through a corresponding arcuate slot in a camming surface. Each camming surface 3 slides within the channel 25 around the plate bolt 3. Each plate bolt 3 provides a limit to the extent to which the associated camming surface 2 can slide around the channel 25. Once the bolt 3 reaches the end of the arcuate slot 2c in the camming surface, it prevents further movement in that direction.

The ramped surface 2b of camming surface 2 bears indirectly against the mounting plate 4 via a respective boss 11. The camming surface 2 therefore exerts a bearing force against a respective portion of the mounting plate 4 via the respective boss 11. Each caroming surface 2 has an adjustment protrusion for hand manipulation of the camming surface 2 within the channel 25. This comprises a lamp centring machine screw 5 that extends through a centring knob 6 and also through corresponding arcuate slots 14, 14g, 14h in the threaded insert. The distal ends of each machine screw 5 are then retained within a respective threaded bore 2f, 2g, 2h in each camming surface 2.

The lamp holder 50 can be installed in a luminaire as shown in FIG. 6a. The channel 1c in the threaded dial 1 is arranged to be retained within the walls of the outer housing of the luminaire 20. The dial is mounted preferably in a split plate, or alternatively with a circlip. This retains the lamp holder 50 in place. A central peak flat module 51 runs along a fixed track in the body of the luminaire 20 to prevent rotation of the entire assembly during movement of the threaded dial 1. The lamp 13 can be accessed through the rear of the assembly via a central aperture 52. It can be removed by twisting the lamp socket 13 using the finger handle 10c, rotating the lamp socket 10 to release the bayonets 10b, 10c and extracting the entire lamp 13 and lamp socket 10 backwards through the rear of the unit.

### USE OF THE ASSEMBLY

The assembly allows for centring of the lamp and adjustment for peak/flat settings of the luminaire. It also allows for extraction of the lamp.

The holder 50 allows the relative tilt of the mounting plate 4 to be adjusted such that the entire lamp mount 30 can be manipulated to align its central axis 61 (see FIG. 6a), and thus the central axis of an installed lamp, with the central/longitudinal axis of the luminaire 60. Once this adjustment has been made the lamp 13 will be aligned, thus providing optimum performance. The tilt of the mounting plate 4 relative to the housing 20/luminaire mount 40 can be achieved by manipulating independently each of the camming surfaces 2, as required. Each camming surface can be manipulated to a desired position to obtain the required tilt.

A camming surface can be manoeuvred within the channel by manoeuvring the corresponding machine screw 5 within corresponding the arcuate channel 14f, 14g, 14h in the threaded insert 14. By manoeuvring a machine screw 5, this will manoeuvre the corresponding camming surface 2 within the channel 25. Doing so will alter the exerted force on the corresponding boss 11, which in turn alters the force exerted by the camming surface 2 indirectly on the mounting plate 4. The extent to which each camming surface 2 can be slid within the arcuate channel 25 is determined by the extent of movement allowed by the machine screw 5 in the corresponding insert slot (14f, 14g, 14h) and the extend of movement allowed by the corresponding plate bolt 3 (as described previously).

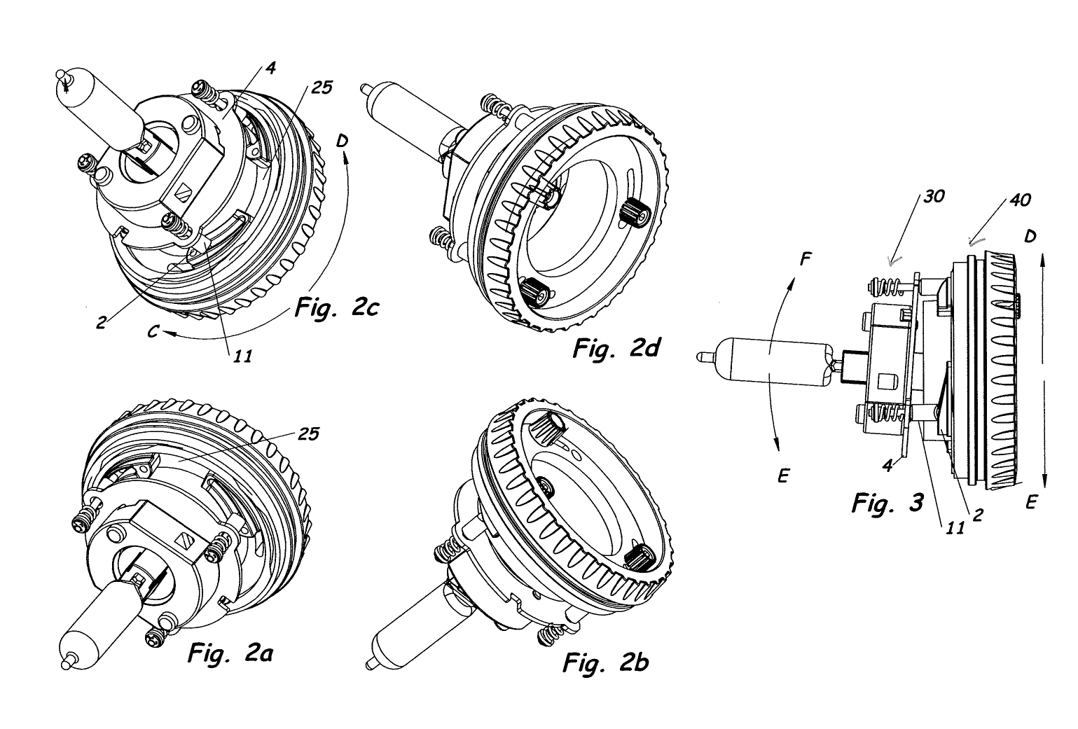

For example, referring to FIG. 2c, manoeuvring the camming surface 2 towards direction B will manoeuvre the lower end of the ramp of the camming surface 2 towards the boss 11. The boss will move downwards closer to insert channel 25. A result of this the bias spring will coerce the mounting plate 4 in the vicinity of the boss 11 towards the channel 25. In effect, by manoeuvring the camming surface 2 in direction B, the displacement between the mounting plate and the channel 25 will be lessened. This drops the mounting plate 4 and as a result tilts the lamp in direction C as shown in FIG. 3.

Conversely, if the camming surface 2 is manoeuvred in direction D the high end of the camming surface 2 will be exerted against the boss 11. This will manoeuvre the mounting plate 4 upwards and increase the displacement between the mounting plate 4 and the channel 25, thereby tilting the portion of the mounting plate in this vicinity towards direction F into the tilt position shown in FIG. 3.

In effect, movement of the camming surface 2 exerts a force directly or indirectly on the mounting plate 4 to alter the displacement between the mounting plate and the channel 25, thus tilting the mounting plate 4 and ultimately the mount to adjust the tilt of the lamp 13. Each camming surface can be independently manoeuvred in this manner to adjust the tilt of the portions as required. Positions of the camming surface 2 between the two extremes can be set to bring the lamp axis into alignment with the luminaire longitudinal axis.

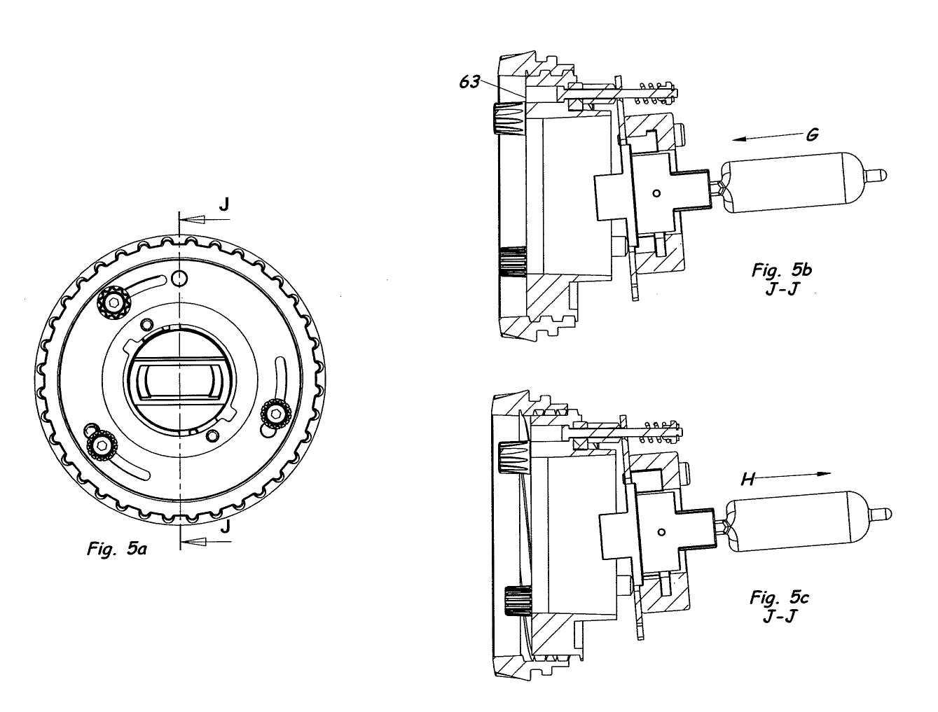

Referring to FIGS. 5b and 5c, by rotating the dial 1, the threaded insert can be moved in a longitudinal direction G/H. By moving the insert, the longitudinal displacement of the lamp can be altered, resulting in altered peak/flat. For example, referring to FIG. 5b, the dial 1 is rotated to its full extent so that the insert is fully retracted into the dial 1 in direction G. This is the “flat” position. Conversely as shown in FIG. 5c, the dial is rotated in the other direction to its full extent, so that the insert is protruding some distance out of the dial 1 in direction H. This is the “peak” position. The multi-start thread allows for quick adjustment, along with the dial providing for convenient adjustment.

### ALTERNATIVES

It is not essential for there to be three camming surfaces. A single camming surface could be provided, or more conveniently two camming surfaces. These would still provide useful adjustment. Three camming surfaces arranged at 60 degree intervals around the circumference of the mounting plate provides the preferred adjustment potential.

It is not essential for the camming surfaces to bear indirectly onto the mounting plate via the protrusions (bosses). Alternatively, the protrusions could be integrally formed with the mounting plate and these could bear directly against the camming surfaces.

The nature of the camming surfaces themselves could vary, and variations would be known to those skilled in the art.

The lamp/lamp base arrangement described above is exemplary only. The invention could use any suitable lamp/lamp base arrangement used in the industry, and the invention should not be considered to be limited to only that arrangement described. For example, the invention can also be used with or can accommodate all known theatrical ‘front lamp’ removal lampbase types including GX8.5, GX12, G12, G9.5, GX9.5, Gy9.5GZX9.5, G22 and GY22 types.

1. An adjustable holder for mounting an illumination source in a luminaire or other lighting apparatus, the holder comprising a mount adapted to hold a lamp or other illumination source and one or more independently adjustable camming surfaces each adapted to directly or indirectly exert a force on the mount to set the mount's tilt.

2. An adjustable holder for an illumination source, the holder comprising a first mount adapted to hold a lamp or other illumination source and a second mount adapted to couple the holder to a luminaire or other lighting apparatus, wherein the first mount can be tilted relative to the second mount via one or more camming surfaces that each directly or indirectly exert a force against a respective position on the first mount, the camming surfaces being independently moveable to adjust the force exerted.

3. An adjustable holder for an illumination source, the holder comprising:
a first mount adapted to hold a lamp or other illumination source,
a second mount adapted to couple the first mount to a luminaire or other light apparatus, and
one or more camming surfaces, each moveably coupled to the second mount and adapted to bear directly or indirectly against the first mount or part thereof,
wherein each camming surface can be manipulated into a range of positions, each position setting a displacement between the second mount and a portion of the first mount.

4. An adjustable holder according to claim 3 wherein the tilt of the first mount relative to the second mount can be configured by manipulating each camming surface into one of a range of positions.

5. An adjustable holder according to claim 3 wherein each camming surface comprises a ramp that slides relative to the second mount.

6. An adjustable holder according to claim 3 wherein each camming surface bears against a protrusion extending from or coupled to the first mount.

7. An adjustable holder according to claim 3 wherein the holder comprises one or more biases to bias the first mount or part thereof against each camming surface.

8. An adjustable holder according to claim 3 wherein each bias comprises a pin extending between the second mount and the first mount, and a biasing spring bearing between the pin and the first mount to bias the first mount or part thereof directly or indirectly against one or more camming surfaces.

9. An adjustable holder according to claim 3 wherein there are three camming surfaces each comprising a ramp that is slidably engaged proximate the surface of the second mount, each camming surface being circumferentially curved and slidable at least partially around the second mount, and each bias comprises a pin extending through an elongated curved slot in each camming surface to couple the first and second mount, the pin comprising a bearing means from which the bias spring extends and bears against the first mount to bias the first mount or part thereof directly or indirectly against the camming surface.

10. An adjustable holder according to claim 3 wherein the protrusion is integrally formed with the first mount.

11. An adjustable holder according to claim 3 wherein the protrusion is disposed on the pin between the first mount and the camming surface.

12. An adjustable holder according to claim 3 wherein a protrusion extends from each camming surface for manipulation of the camming surface.

13. A luminaire comprising an adjustable holder according to claim 3.

14. An adjustable holder according to claim 3 wherein the first mount is coupled to the second mount via a threaded insert, wherein rotation of the second mount retracts and/or extends the threaded insert to adjust the axial position of the first mount to adjust peak/flat of an installed lamp or other illumination device.

15. An adjustable holder according to claim 3 wherein the first mount or part thereof can be extracted from the second mount to remove the lamp.

16. A luminaire with an adjustable holder for mounting an illumination source in a luminaire or other lighting apparatus, the holder comprising a mount adapted to hold a lamp or other illumination source and one or more independently adjustable camming surfaces each adapted to directly or indirectly exert a force on the mount to set the mount's tilt.

17. An adjustable holder for mounting an illumination source in a luminaire or other lighting apparatus, the holder comprising a mount adapted to hold a lamp or other illumination source wherein the first mount is coupled to a second mount via a threaded insert, wherein when the second mount is installed in a luminaire, rotation of the second mount retracts and/or extends the threaded insert to adjust the axial position of the first mount to adjust peak/flat of an installed lamp or other illumination device.

18. A luminaire with an adjustable holder for mounting an illumination source in a luminaire or other lighting apparatus, the holder comprising a mount adapted to hold a lamp or other illumination source wherein the first mount is coupled to a second mount via a threaded insert, wherein the second mount is coupled to the luminaire, and wherein rotation of the second mount retracts and/or extends the threaded insert to adjust the axial position of the first mount to adjust peak/flat of an installed lamp or other illumination device.

19. An adjustable holder substantially as hereinbefore described with reference to the accompanying drawings.

20. A luminaire substantially as hereinbefore described with reference to the accompanying drawings.
